(19) United States
(12) Patent Application Publication
(10) Pub. No.: US 2010/0231404 A1
(43) Pub. Date: Sep. 16, 2010

(54) ILLUMINATION SYSTEM HAVING AN ARRAY OF LIGHT SOURCES

(75) Inventors: Peter A. Duine, Eindhoven (NL); Willem L. Ijzerman, Eindhoven (NL)

Correspondence Address: Philips Intellectual Property and Standards, P.O. Box 3001, Briarcliff Manor, NY, 10510-8001, US

(73) Assignee: KONINKLIJKE PHILIPS ELECTRONICS N V, Eindhoven (NL)

(21) Appl. No.: 12/377,668

(22) PCT Filed: Sep. 18, 2007
(86) PCT No.: PCT/IB07/53764

§ 371 Date: Feb. 16, 2009

(30) Foreign Application Priority Data
Sep. 22, 2006 (EP) 06121098.5

(51) Int. Cl. G08B 21/00

(52) U.S. Cl. 340/686.6

(57) ABSTRACT

An illumination system (1) comprises a plurality of light source units (10) arranged according to an array, each light source unit comprising at least one controllable light source (12) and a unit controller (11). A communication network (30) has communication lines (32; 33) extending along a straight line between neighboring light source units (1OA, 1OB; 1OB, 10C). A common system controller (20) issues control signals (Sc) for the individual unit controllers (11), taking into account their positions and orientations, to achieve a desired illumination effect. The common system controller is capable of automatically determining the positions and orientations of the light source units (10). To this end, the light source units comprise length detection means (60) for detecting the lengths of the communication lines, and direction detection means (50) for detecting the relative directions of the communication lines, and communicate the measured results to the common system controller.

### FIELD OF THE INVENTION

The present invention relates in general to illumination systems, and more particularly to a system comprising a plurality of light sources arranged according to an array.

### BACKGROUND OF THE INVENTION

An example of such system is for instance disclosed in WO-2004/094896, where the light-sources are tile-shaped. The system comprises a plurality of LEDs arranged along a ceiling or a wall or a floor of a room. Each LED can be controlled such that the intensity and color of its light output can be set to desired values within predetermined ranges. At a certain location in the room, multiple (not necessarily all) LEDs of the plurality may contribute to the illumination. The LEDs are controlled by a common controller such as to achieve a certain desirable lighting effect in the room, for instance a pattern of colored stripes. To achieve this effect, the controller calculates and generates individual control signals for each individual light-source, or even to each individual LED of the light-sources. Such individual control signal depends on the location of the individual light-source in the array.

In the system of the said document, the positions of the individual light-sources are considered to be known. However, the document does not disclose how information regarding the positions of the individual light-sources is obtained. One way of obtaining this information is actually measuring the three-dimensional spatial coordinates of each light source and inputting these spatial coordinates into the controller or an associated memory. However, this is rather laborious and time-consuming work, especially in cases where the light sources are arranged in a random pattern rather than in a regular array so that it is not possible to simply calculate the spatial coordinates of the remaining light sources once the spatial coordinates of a few light sources have been measured. Further, if for any reason the position of one or more of the light sources is changed, the measuring process must be repeated.

### SUMMARY OF THE INVENTION

It would be advantageous if the controller were capable of automatically determining the individual positions of the light sources.

For addressing each individual light source and transmitting the individual control signals to the individual light source, it would in principle be possible that an individual communication path is provided between the controller and each light source. However, this would be very unpractical, especially with a view to the space occupied by the large number of communication paths close to the controller in the case of conductive wires. Thus, it is more advantageous if the system comprises one communication path from the controller to one light source, while further light sources are coupled to this one light source, either directly or through one or more other light sources. A control signal is provided with an address code corresponding to a certain light source. The control signal is received by all light sources, but only the one light source having the correct address will respond. Thus, each light source (except the first one) is always coupled to another light source from which it receives the control signals through a communication line. According to the present invention, the distance between these two light sources can be calculated from the length and direction of the communication line. Ultimately, the topology of the entire array can be determined in this way.

Using this insight, the present invention provides a system as described above, wherein a light source is designed to calculate the length and direction of the communication line with a neighboring light source, and to communicate this information to the controller. In an initialization phase, for instance when the system is switched on, the controller receives this information and calculates the relative positions of the light sources with respect to each other.

Further advantageous elaborations are mentioned in the dependent claims.

### BRIEF DESCRIPTION OF THE DRAWINGS

These and other aspects, features and advantages of the present invention will be further explained by the following description of one or more preferred embodiments with reference to the drawings, in which same reference numerals indicate same or similar parts, and in which:

FIG. 1 is a block diagram schematically illustrating an illumination system;

FIGS. 2A-B are schematic cross-sections of a room with an illumination system;

FIG. 3 schematically illustrates a light source unit;

FIG. 4 is a schematic plan view of a housing of a light source unit.

### DETAILED DESCRIPTION OF THE INVENTION

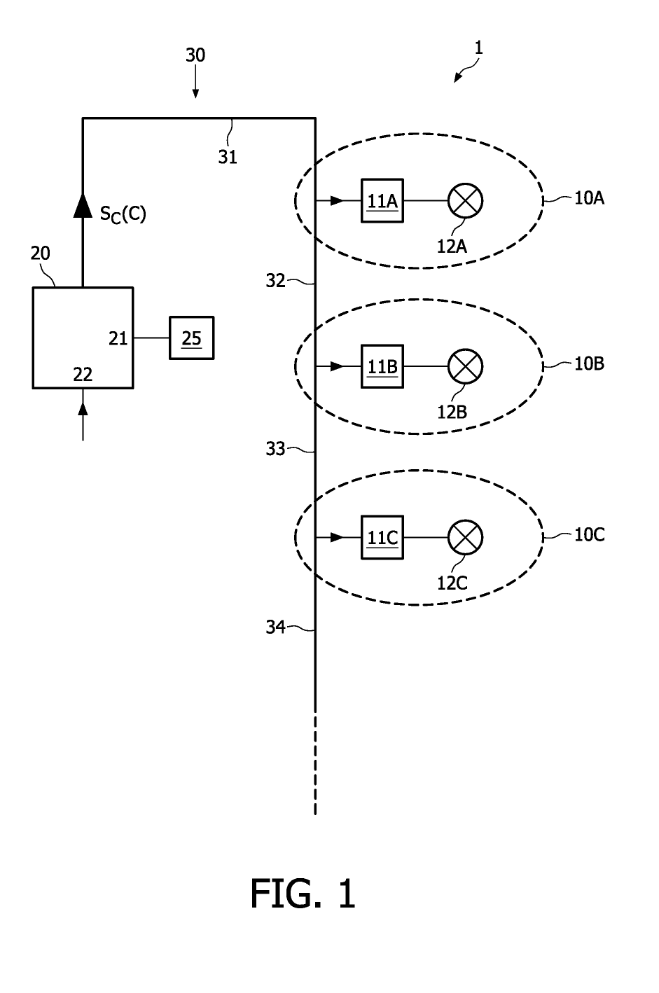

FIG. 1 schematically shows a block diagram of an illumination system 1, comprising a plurality of light source units 10. In the figure, three of such units are shown, distinguished by addition of the letters A, B, C. Each light source unit 10 comprises an actual light source 12, particularly implemented as a LED, and a unit controller 11, also distinguished by addition of the letters A, B, C in FIG. 1. The system 1 further comprises a central controller 20, also indicated as system controller, which communicates with the unit controllers 11. The system controller 20 generates a control signal Sc, which is received by all unit controllers 11. The control signal Sc, containing data relating to desired color and magnitude, is intended for only one of the light source unit 10. To that end, the control signal also contains address data relating to the intended recipient light source unit, such control signal will be indicated as an “addressed” control signal. Assume that the control signal Sc is intended for the third light source unit 10C only; the addressed control signal Sc for such case will be written as Sc(C).

The system 1 comprises a communication network 30 for distributing the addressed control signals to the unit controllers 11. The communication network 30 comprises a first communication line 31 between the system controller 20 and the first light source unit 10A. The communication network 30 comprises a second communication line 32 between the first light source unit 10A and the second light source unit 10B. The communication network 30 may comprise one or more communication lines coupling the first light source unit 10A to one or more further light source units, but this is not shown. The communication network 30 comprises a third communication line 33 between the second light source unit 10B and the third light source unit 10C. The communication network 30 may comprise one or more communication lines coupling the second light source unit 10B to one or more further light source units, but this is not shown. The communication network 30 comprises a fourth communication line 34 between the third light source unit 10C and a next light source unit (not shown). The communication network 30 may comprise one or more communication lines coupling the third light source unit 10C to one or more further light source units, but this is not shown.

The control signal Sc is received by all unit controllers, actually traveling from the system controller 20 to the first light source unit 10A over the first communication line 31, from the first light source unit 10A to the second light source unit 10B over the second communication line 32, and from the second light source unit 10B to the third light source unit 10C over the third communication line 33. Each unit controller checks the address data of the control signal to see whether the control signal is intended for that unit controller; if not, the unit controller takes no action. In this example, only the third unit controller 11C will respond to the control signal Sc(C).

In a typical embodiment, the light source 12 comprises a combination of three LEDs of mutually different colors (RGB) or four LEDs of mutually different colors-color (RGBW), so that the light source 12 is capable of generating light of which the color point can be varied over a wide range in the color triangle and of which the magnitude can be varied over a wide range. The unit controller 11 is designed to generate suitable drive signals for the individual LEDs so that the desired color and magnitude is achieved, in response to the control signal Sc, which contains information about the desired color and magnitude. Since this is known per se, a more elaborate description of the LED control is omitted here. However, it is noted that the light source 12 may be constituted by a multi-color LED. Further, in order to increase brightness, it is possible that the light source 12 is constituted by a plurality of LEDs, and it is possible that the LEDs are controlled in parallel but it is within the scope of the present invention that the individual LEDs are controlled individually with possibly mutually different control signals.

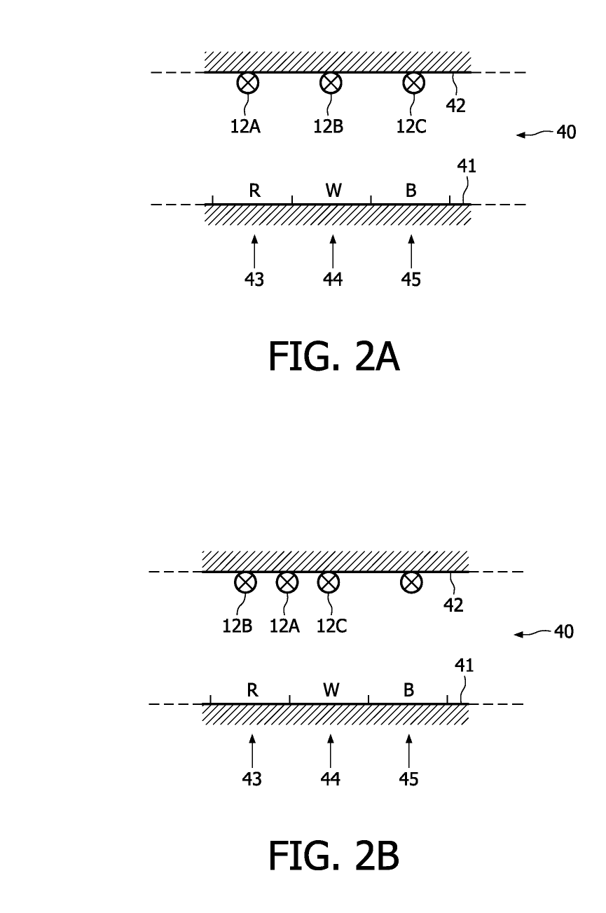

Apart from the address data, the control signal thus contains drive data telling the unit controller how to drive the LED, the drive data relating to color and magnitude. The drive data is generated by the system controller 20 on the basis of on the one hand the spatial illumination effect to be achieved and on the other hand the spatial locations of the light sources. For illustrative purposes, a simple example is shown in FIGS. 2A-2B.

FIGS. 2A-B are schematic cross-sections of a room 80 having a floor 81 and a ceiling 82. Light sources 12A, 12B, 12C of the illumination system 1 are mounted in the ceiling 82. The system controller 20 is programmed to achieve illumination of the floor 81 such that a first zone 83 is substantially red, a second zone 84 is substantially white, and a third zone is substantially blue. In FIG. 2A, the three light sources 12A, 12B, 12C are aligned with these three zones. Then, it should be clear to a person skilled in the art that the first light source 12A should be driven to generate red light, the second light source 12B should be driven to generate white light, and the third light source 12C should be driven to generate blue light.

Now, assume that the light sources are re-arranged, such that the second light source 12B is aligned with the first zone 83, the third light source 12C is aligned with the second zone 84, and the first light source 12A is aligned with a boundary between the first and second zones, as illustrated in FIG. 2B. In that case, it should be clear to a person skilled in the art that the second light source 12B should be driven to generate red light, the third light source 12C should be driven to generate white light, and the first light source 12A should be driven to generate light suitable for illuminating said boundary zone, which may, depending on the circumstances, mean that the first light source 12A should generate pale red light (i.e. having a color point between red and white) or should be switched off.

The spatial illumination effect to be achieved may be preprogrammed into the system controller 20, or the system controller 20 may have an input 21 for receiving information defining the spatial illumination effect. For being capable of determining the illumination contribution of each individual light source, and thus to be capable of generating the individual control signals, the system controller 20 needs to have information defining the spatial locations of the individual light sources. This information will be indicated as location information or coordinates.

FIG. 1 illustrates that the system controller 20 is associated with a coordinate memory 25, containing the location information of the light sources. The system controller 20 receives the location information from the coordinate memory 25 at a coordinate input 22. A key aspect of the present invention is the problem of how to obtain the location information in the first place, for inputting into the memory 25.

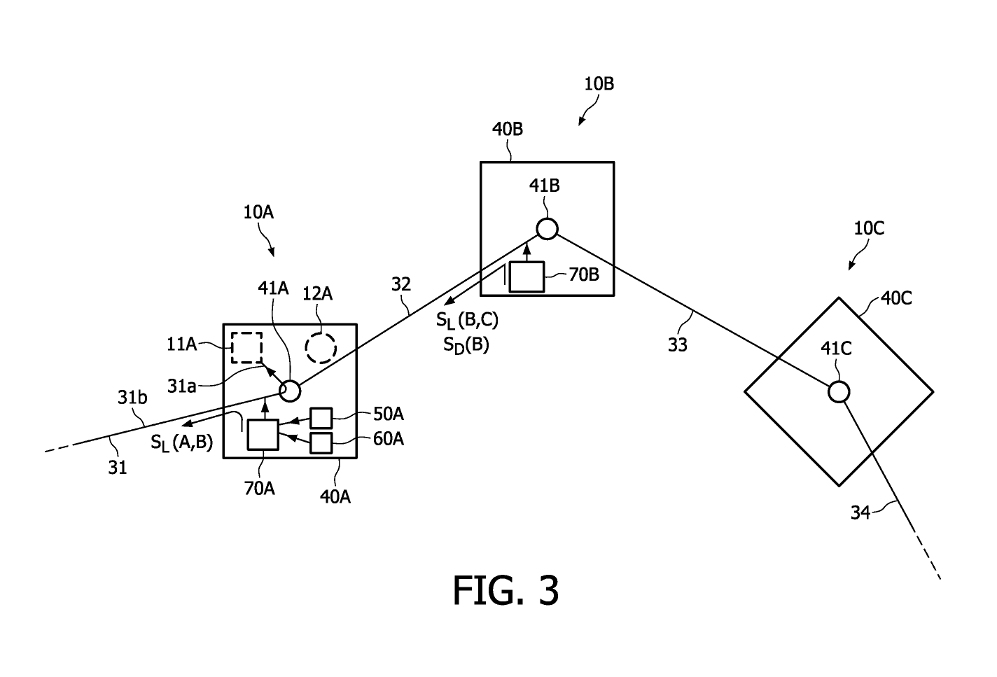

FIG. 3 schematically shows constructional details of the light source units 10A, 10B, 10C. Each light source unit 10 has a tile-shaped housing 40. The contour of this housing is not essential; in FIG. 3 the contour is shown to be square, but it may be rectangular, triangular, circular, or any other suitable shape.

The unit controller 11 is mounted at a certain predetermined position on or in the housing. The exact positioning of the unit controller 11 is not essential; in FIG. 3, a possible position of the unit controller 11 is shown in dashed lines.

One or more LEDs, constituting the light source 12, are mounted at certain predetermined positions on or in the housing. The exact positioning of the LEDs is not essential; in FIG. 3, a possible position of a LED 12 is shown in dashed lines. It is noted that, generally, the LEDs are mounted on an opposite side with respect to the unit controller 11, as the LEDs are intended to give light to a room while the unit controller 11 preferably is mounted out of sight.

It is noted that there will be conductors coupling the light source 12 to the unit controller 11; such conductors are not shown for sake of convenience.

Each housing 40 is provided with a predefined communication line coupling device 41 having a predefined location on the housing 40. The coupling device 41 is a device where the communication lines always meet the housing. For instance, referring to housing 40A, FIG. 3 shows that the incoming communication line 31 from the system controller 20 meets the coupling device 41A of the housing 40A, and that the outgoing communication line 32 to the next housing 40B goes out from the coupling device 41A of the housing 40A.

In FIG. 3, the coupling device 41 is shown to be located at the centre of the housing 40, but this is not essential. The unit controller 11 may be located at the same location as the coupling device 41, but this is not necessary. FIG. 3 shows a certain distance between the coupling device 41 and the unit controller 11. This implies that the incoming communication line 31 has a line portion 31a extending from the coupling device 41 to the unit controller 11 making an angle with the main portion 31b of the communication line 31. Thus, the coupling device 41 is not necessarily equal to the location where the incoming communication line 31 ends. For instance, in case the incoming communication line 31 is an electrical cable, the coupling device 41 may comprise a cable clamp or the like, but it is also possible that the coupling device 41 comprises a cable connector.

Further, the design and nature of the coupling device 41 is not essential. As mentioned, it may comprise a cable clamp or cable connector for cooperation with an electrical cable. In the case of optical communication, the communication line being implemented by an optical path, the coupling device 41 may comprise an optical sensor or the like. In the case of electromechanical wave, for instance radio wavelength, the coupling device 41 may comprise an antenna.

In FIG. 3, the coupling device 41 is shown as being common to the incoming communication line 31 and the outgoing communication line 32, but this is not essential: it is also possible that the housing 40 has separate coupling devices for the different communication lines, located at mutually different positions.

A key feature of the present invention is that each communication line follows a straight line between two coupling devices of two housings 40 of two different light source units 10. In case a communication line is an electrical cable, this means that the cable is mounted in a taut condition between two coupling devices. In case of rearrangement of the light source units, the personnel performing the mounting must assure the taut condition of the communication lines. It goes without saying that the straight line condition is fulfilled automatically in the case of optical communication, radio communication, etc.

A further key feature of the present invention is that each light source unit 10 comprises direction detection means 50 for detecting the direction of a communication line with respect to the housing 40. Possible embodiments of such direction detection means will be discussed later.

A further key feature of the present invention is that each light source unit 10 comprises length detection means 60 for detecting the length of a communication line. Possible embodiments of such direction detection means will be discussed later.

A further key feature of the present invention is that each light source unit 10 comprises a processor 70 for processing the detector signals of the corresponding direction detection means 50 and length detection means 60, to calculate direction and distance signals from these detector signals, and to send to the system controller 20 an addressed location signal S_{L} containing the calculated direction and distance signals, together with identification data identifying the sender and its neighbor. The transmission can be performed over the communication network 30, using the address of the system controller 20 as intended receiver, as should be clear to a person skilled in the art. The processor 70 may be separate from the unit controller 11, but it is also possible that the task of the processor 70 is performed by the unit controller 11.

It is noted that, in general, the location of an object in space can be described with three spatial coordinates, and that its orientation can be described with three angular coordinates. However, it is assumed that the light source units are arranged in a common plane, for instance corresponding to the ceiling of a room, so the location can be described with two spatial coordinates. It is further assumed that each housing has a predefined up/down direction, corresponding to the optical axes of the LEDs, and that all housings are mounted with their said up/down directions perpendicular to the said common plane, so the orientation can be described with one angular coordinate. It further follows that the communication lines between neighboring housings extend in or at least parallel to said common plane.

In the following explanation, for sake of convenience it will be assumed that the location of the first light source unit 10A and the orientation of the first housing 40A are known. The first processor 70A receives the detector signals from the first direction detection means 50A and the first length detection means 60A relating to the second communication line 32 between the first light source unit 10A and the second light source unit 10B. From this information, the first processor 70A calculates direction and length of the second communication line 32 with respect to the first housing 40A, and sends an addressed location signal S_{L}(A,B) containing this information to the system controller 20. Using this information, the system controller 20 can calculate the location of the second housing 40B with respect to the first housing 40A and, since the location and orientation of the first housing 40A is known, the system controller 20 can calculate the absolute location of the second housing 40B in space, or at least in the room 80. It is noted that the orientation of the second communication line 32 can also be calculated.

The second processor 70B receives the detector signals from the second direction detection means 50B relating to the second communication line 32 between the first light source unit 10A and the second light source unit 10B. From this information, the second processor 70B calculates the direction of the second communication line 32 with respect to the second housing 40B, and sends an addressed direction signal S_{D}(B) containing this information to the system controller 20. Using this information, the system controller 20 can calculate the orientation of the second housing 40B with respect to the second communication line 32 and, since the orientation of the second communication line 32 is known, the system controller 20 can calculate the absolute orientation of the second housing 40B in space, or at least in the room. Since the system controller 20 also knows the location and orientation of the light effect to be achieved in the room 80, the system controller 20 now knows the location and orientation of the second light source 10B with respect to the light effect.

The second processor 70B receives the detector signals from the second direction detection means 50B and the second length detection means 60B relating to the third communication line 33 between the second light source unit 10B and the third light source unit 10C. From this information, the second processor 70B calculates direction and length of the third communication line 33 with respect to the second housing 40B, and sends an addressed location signal S_{L}(B,C) containing this information to the system controller 20. Using this information, the system controller 20 can calculate the location of the third housing 40C with respect to the second housing 40B and, since the location and orientation of the second housing 40B is known, the system controller 20 can calculate the absolute location of the third housing 40C. From direction signal S_{D}(C) from the third processor 70C, the system controller 20 can calculate the orientation of the third housing 40C.

Thus, the system controller 20 can calculate the absolute locations and orientations of all light source units.

In the above explanation, the system controller 20 uses direction and length information S_{L}(A,B) from a first light unit 10A to calculate the position of the next light unit 10B, and uses direction information S_{D}(B) from this next light unit 10B to calculate its orientation. It is also possible that the system controller 20 uses length information obtained from the next light unit 10B, either instead of the length information obtained from the previous light unit 10A or to be averaged with the length information obtained from the previous light unit 10A.

It is noted that the operation described above by the processors 70 may be performed continuously, but is also possible that this operation only takes place in a measuring mode, or on start-up of the system.

Summarizing, it should be clear for a person skilled in the art from studying the above explanation that the absolute locations and orientations of all light source units 10 (i.e. housings 40) can be calculated if the lengths of the relevant communication lines (32, 33, etc) are known, and if the orientations of the relevant communication lines (32, 33, etc) with respect to respective housings 40 are known.

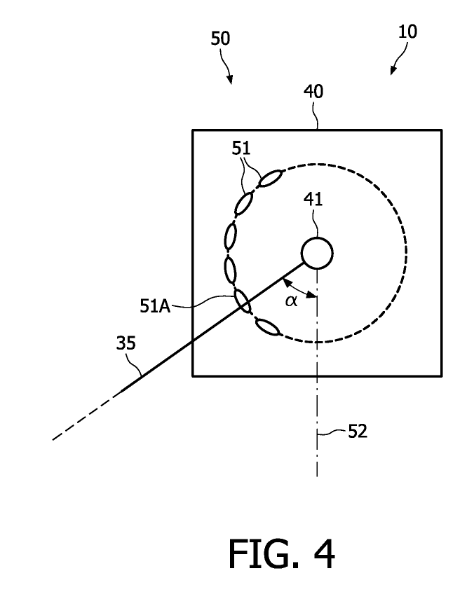

FIG. 4 is a schematic plan view of a housing 40 of a light source unit 10, illustrating that the direction detection means 50 comprise a plurality of line sensors 51 arranged around the coupling device 41. FIG. 4 shows the sensors 51 arranged in a circle, but this is not essential. In a possible embodiment, the sensors 51 are arranged along the perimeter of the housing. It should be clear that the sensors 51 have sensor outputs coupled to respective sensor inputs of the processor 70 discussed above, but this is not shown for sake of convenience. Since the sensors 51 are arranged around the coupling device 41, a communication line 35 coupled to the coupling device 41 will always cross the line of sensors 51. In FIG. 4, the communication line 35 crosses one sensor, indicated as 51A. Each line sensor 51 is designed to detect the crossing of a communication line, and to generate a sensor output signal indicating that a communication line is or is not crossing. Thus, sensor 51A will issue a sensor signal indicating the crossing by a communication line, while the other sensors in the Figure. will issue sensor signals indicating that they are not crossed by a communication line.

Each sensor 51 defines a specific direction of the communication line with respect to the fixed position of the coupling device 41, this specific direction being determined by the specific position of the sensor. This direction can be expressed as an angle a with respect to a zero-axis 52 intersecting the coupling device 41. The direction of the zero-axis 52 with respect to the housing 40 is arbitrary, yet fixed and known.

In angular direction, the sensors 51 have an angular size and angular distance with respect to each other, which determines the accuracy of the direction measurement. If the angular size and angular distance of the sensors decreases, the number of sensors and the measuring accuracy increase, but so do the costs.

Several embodiments are possible for the sensors 51. In the case of the communication line being a physical conductor carrying electrical signals, a sensor can be implemented as a capacitive sensor capacitively picking up the signals of the communication line, or the sensor can be implemented as an inductive sensor inductively picking up the signals of the communication line. It is also possible that a sensor is a mechanical sensor, responding to mechanical contact with the communication line. It is also possible that a sensor is an optical sensor, for instance an optical gate, the detection principle being based on interrupting an optical signal. It is also possible that a sensor is an electro-mechanical sensor, such as an RF-tag, responding to the electromagnetic field of a communication line. Since examples of the above-mentioned sensor types are known per se while the present invention can be implemented with known sensors, it is not necessary here to discuss the details of construction and design of the sensors 51 in more detail.

Several embodiments are possible for the length detection means 60. In a possible embodiment, the communication lines have a predetermined resistivity (resistance per unit length) and the length detection means 60 comprise means for measuring the resistance of the communication lines; from this, the length can be calculated if the resistivity is known. Since means for measuring resistance of an electrical conductor are known per se, it is not necessary here to discuss the details of construction and design of the length detection means 60 in more detail. It is noted that in this example, the length detection means 60 may be designed for measuring voltage over and current through the communication lines, while the processor 70 may be designed to calculate resistance. Further, it is noted that the processor 70 may be designed to send the resistance value to the system controller 20, but it is also possible that the processor 70 calculates length and is designed to send the length value to the system controller.

In another possible embodiment, each communication line is wound on a reel. For connection with another light source unit, the communication line is unwound from the reel. The number of turns made by the reel indicates the length of line wound from the reel.

In the above, the invention is explained for a case where the effect-to-be-achieved is an illumination effect. However, it is also possible that the effect-to-be-achieved is a display of a picture, in which case each light source has a function of a pixel in the display. In contrast to common displays, where pixels are arranged in an array of rows and columns, the present invention allows for a random distribution of the pixels.

In the above, the invention is explained for an embodiment where each light source is addressed individually. The system controller 20 knows the location and orientation of each individual light source, it knows the effect-to-be-achieved, so it knows the required behavior of each individual light source, i.e. the required light output of each individual light source: in the above-described embodiment, an individual control signal for the individual light source is generated, provided with address information, and the receiving light sources know which control signals to obey and which to ignore. However, it is also possible that information regarding the location and orientation of an individual light source is communicated to this light source, so that this light source knows where it is located in the system. It is then possible to send to all light sources of the system control information relating to the required behavior of the system as a whole, i.e. defining the effect-to-be-achieved; for instance, this information may define a picture to be displayed. Each light source knows, on the basis of its location and orientation, what its contribution to the overall effect should be (it knows which portion of the display should be displayed by it). Each light source controller receives the same overall information (defining the overall picture), derives from this overall information specific information defining the required display effect at its position, and generates a drive signal for the corresponding LED(s) on the basis of this derived information. In other words, it is possible to send an image to the system of light sources, all light sources receiving the same information, while each light source automatically derives the correct drive information on the basis of its location and orientation in the system. A big advantage of such embodiment would be that it is possible to add elements to the system without the central controller needing to define address information for such element. The number of elements can be extended freely, without the central controller even needing to know the number of elements.

Summarizing, the present invention provides an illumination system that comprises a plurality of light source units arranged according to an array, each light source unit comprising at least one controllable light source and a unit controller. A communication network has communication lines extending along a straight line between neighboring light source units. A common system controller issues control signals for the individual unit controllers, preferably through said communication network, taking into account their positions and orientations, to achieve a desired illumination effect. The common system controller is capable of automatically determining the positions and orientations of the light source units. To this end, the light source units comprise length detection means for detecting the lengths of the communication lines, and direction detection means for detecting the relative directions of the communication lines, and communicate the measured results to the common system controller, preferably through said communication network.

While the invention has been illustrated and described in detail in the drawings and foregoing description, it should be clear to a person skilled in the art that such illustration and description are to be considered illustrative or exemplary and not restrictive. The invention is not limited to the disclosed embodiments; rather, several variations and modifications are possible within the protective scope of the invention as defined in the appending claims.

It is noted that the light source units require power. In a possible embodiment, each individual light source unit is individually connected to mains. However, it is also possible that the system 1 comprises a power distribution network. In a possible embodiment, the communication network 30 is designed for distributing power as well as control signals. This can easily be achieved in case the power is distributed using DC power while the control signals and measuring signals are signals in an AC frequency band. It is even possible that the power is distributed using AC power at a relatively low frequency range, for instance 50 Hz, while the control signals and measuring signals are signals in an AC frequency band well above 50 Hz, for instance in the kHz-MHz range. However, it is also possible to use two separate networks, one for distributing power and the other for distributing control signals and measuring signals. In such case, it is possible that the communication lines for distributing power are used for detecting direction and length. In such case, it is even possible that control signals Sc and measuring signals S_{L} and S_{D} are transmitted over a wireless network.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measured cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

In the above, the present invention has been explained with reference to block diagrams, which illustrate functional blocks of the device according to the present invention. It is to be understood that one or more of these functional blocks may be implemented in hardware, where the function of such functional block is performed by individual hardware components, but it is also possible that one or more of these functional blocks are implemented in software, so that the function of such functional block is performed by one or more program lines of a computer program or a programmable device such as a microprocessor, microcontroller, digital signal processor, etc.

1. Illumination system, comprising:
a plurality of light source units arranged in an array, each light source unit comprising at least one controllable light source and a unit controller for controlling the light source;
a common system controller for issuing control signals (Sc) for the unit controllers;
a communication network having communication lines extending along a straight line between neighboring light source units and having at least one communication line between the common system controller and a first light source unit; wherein each light source unit comprises:
(i) length detection means for detecting the length of at least one communication line coupled to that light source unit;
(ii) direction detection means for detecting the relative direction of at least one communication line coupled to that light source unit;
(iii) a processor receiving one or more output signals from the corresponding length detection means and direction detection means, the processor being configured to derive from the output signals from the corresponding length detection means a first signal representing the length of said at least one communication line and sending the first signal to the common system controller, the processor being further configured to derive from the output signals from the corresponding direction detection means a second signal representing the direction of said at least one communication line and sending the second signal to the common system controller; wherein the common system controller is operative to receive the signals from the processors of all light source units, and to calculate therefrom the positions and orientations of at least one light source unit.

2. Illumination system according to claim 1, wherein the common system controller is operative to calculate a control signal (Sc) for the at least one light source unit based at least in part on the calculated position and orientation thereof.

3. Illumination system according to claim 2, wherein the system controller is operative to add to the control signal (Sc) address information defining the intended receiving light source unit, wherein the control signal (Sc) together with the added address information is transmitted to all light source units in common, and wherein each light source unit is responsive to a received control signal (Sc) only if the associate address information corresponds to its own address.

4. Illumination system according to claim 1, wherein the system controller is operative to transmit to all light source units in common an overall control signal defining an effect-to-be-achieved, and wherein each individual unit controller is operative, on the basis of its position and orientation in the system, to derive from the received overall control signal specific control information for its associated light source.

5. Illumination system according to claim 1, wherein the system controller is operative to calculate the positions and orientations of all light source units of the plurality of light source units.

6. Illumination system according to claim 1, wherein the processor of each light source unit sends the first and the second signals to the system controller over the communication lines of the communication network.

7. Illumination system according to claim 1, wherein the system controller sends the control signals to the unit controllers over the communication lines of the communication network.

8. Illumination system according to claim 1, wherein a communication line comprises a conductive wire held taut between two light source units.

9. Illumination system according to claim 8, wherein the length detection means are configured to measure the resistance of the communication line.

10. Illumination system according to claim 1, wherein the at least one light source unit comprises a housing and a coupling device to which the communication line is coupled, and wherein the direction detection means comprise a plurality of line sensors arranged around the coupling device, each line sensor capable of detecting the proximity of the communication line.

11. Illumination system according to claim 10, wherein the communication line comprises a conductive wire, and wherein each line sensor is configured to capacitively or inductively detect the signals conducted by the communication line.

12. Illumination system according to claim 10, wherein the communication line comprises a conductive wire, and wherein each line sensor is configured to mechanically or optically detect the presence of the communication line.

13. Method for automatically determining the positions and orientations of light source units in an illumination system, the method comprising the steps of:
a) providing a first light source unit with known position and orientation;
b) providing a straight communication line between the first light source unit and a subsequent light source unit;
c) determining the length of said communication line;
d) determining the direction of said communication line with respect to the first light source unit;
e) determining the absolute direction of said communication line from the direction determined in step d, taking into account the known orientation of the first light source unit;
f) determining the position of the subsequent light source unit from the length determined in step c and the absolute direction determined in step d, taking into account the known position of the first light source unit;
g) determining the direction of said communication line with respect to the subsequent light source unit; and
h) determining the orientation of the subsequent light source unit from the direction determined in step g, taking into account the absolute direction determined in step d.

14. Method according to claim 13, wherein step d is performed by measuring means on board of the first light source unit and the measuring result is communicated to a central controller of the system; wherein step g is performed by measuring means on board of the subsequent light source unit and the measuring result is communicated to the central controller; and wherein steps e, f and h are performed by the central controller.

15. Method according to claim 14, wherein step c is performed by measuring means on board of the first light source unit and the measuring result is communicated to the central controller.

16. Method according to claim 14, wherein step c is performed by measuring means on board of the subsequent light source unit and the measuring result is communicated to the central controller.

17. Method according to claim 13, wherein the light source units are controllable light source units, and wherein the central controller generates individual control signals for the individual light source units taking into account their positions and orientations.

18. Method according to claim 13, wherein the light source units are controllable light source units, wherein the central controller generates an overall control signal for all light source units in common, and wherein a light source unit calculates from the overall control signal an individual control signal taking into account its position and orientation.
